(19) United States
(12) Patent Application Publication
(10) Pub. No.: US 2023/0106873 A1
(43) Pub. Date: Apr. 6, 2023

(54) TEXT EXTRACTION METHOD, TEXT EXTRACTION MODEL TRAINING METHOD, ELECTRONIC DEVICE AND STORAGE MEDIUM

(71) Applicant: BEIJING BAIDU NETCOM SCIENCE TECHNOLOGY CO., LTD., BEIJING (CN)

(72) Inventors: Xiameng QIN, Beijing (CN); Xiaoqiang ZHANG, Beijing (CN); Ju HUANG, Beijing (CN); Yulin LI, Beijing (CN); Qunyi XIE, Beijing (CN); Kun YAO, (US); Junyu HAN, Beijing (CN)

(21) Appl. No.: 18/059,362

(22) Filed: Nov. 28, 2022

(30) Foreign Application Priority Data
Mar. 10, 2022 (CN) 202210234230.9

(51) Int. Cl. G06V 20/62; G06V 30/18; G06V 30/19; G06V 10/80

(52) U.S. Cl. CPC G06V 20/62; G06V 30/18; G06V 30/19013; G06V 10/806; G06V 30/19127; G06V 30/19147; G06V 30/19173

(57) ABSTRACT

A text extraction method and a text extraction model training method are provided. The present disclosure relates to the technical field of artificial intelligence, in particular to the technical field of computer vision. An implementation of the method comprises: obtaining a visual encoding feature of a to-be-detected image; extracting a plurality of sets of multimodal features from the to-be-detected image, wherein each set of multimodal features includes position information of one detection frame extracted from the to-be-detected image, a detection feature in the detection frame and first text information in the detection frame; and obtaining second text information matched with a to-be-extracted attribute based on the visual encoding feature, the to-be-extracted attribute and the plurality of sets of multimodal features, wherein the to-be-extracted attribute is an attribute of text information needing to be extracted.

### CROSS-REFERENCE TO RELATED APPLICATION

This application claims priority to Chinese Patent Application No. 202210234230.9 filed on Mar. 10, 2022, the contents of which are hereby incorporated by reference in their entirety for all purposes.

### TECHNICAL FIELD

The present disclosure relates to the technical field of artificial intelligence, and in particular to the technical field of computer vision.

### BACKGROUND

In order to improve efficiency of information transfer, a structured text has become a common information carrier and is widely applied in digital and automated office scenarios. There is currently a large amount of information in entity documents that needs to be recorded as an electronically structured text. For example, it is necessary to extract information in a large number of entity notes and store them as the structured text to support intelligentization of enterprise office.

### SUMMARY

The present disclosure provides a text extraction method, a text extraction model training method, an electronic device and a computer-readable storage medium.

According to an aspect of the present disclosure, a text extraction method is provided, including:

obtaining a visual encoding feature of a to-be-detected image;

extracting a plurality of sets of multimodal features from the to-be-detected image, wherein each set of multimodal features includes position information of one detection frame extracted from the to-be-detected image, a detection feature in the detection frame and first text information in the detection frame; and

obtaining second text information matched with a to-be-extracted attribute from the first text information included in the plurality of sets of multimodal features based on the visual encoding feature, the to-be-extracted attribute and the plurality of sets of multimodal features, wherein the to-be-extracted attribute is an attribute of text information needing to be extracted.

According to an aspect of the present disclosure, a text extraction model training method is provided, wherein a text extraction model includes a visual encoding sub-model, a detection sub-model and an output sub-model, and the method includes:

obtaining a visual encoding feature of a sample image extracted by the visual encoding sub-model;

obtaining a plurality of sets of multimodal features extracted by the detection sub-model from the sample image, wherein each set of multimodal features includes position information of one detection frame extracted from the sample image, a detection feature in the detection frame and first text information in the detection frame;

inputting the visual encoding feature, a to-be-extracted attribute and the plurality of sets of multimodal features into the output sub-model to obtain second text information matched with the to-be-extracted attribute and output by the output sub-model, wherein the to-be-extracted attribute is an attribute of text information needing to be extracted; and

training the text extraction model based on the second text information matched with the to-be-extracted attribute and output by the output sub-model and text information actually needing to be extracted from the sample image.

According to an aspect of the present disclosure, an electronic device is provided, including:

at least one processor; and

a memory in communication connection with the at least one processor; wherein

the memory stores instructions executable by the at least one processor, and the instructions are executed by the at least one processor, so as to enable the at least one processor to perform operations comprising:

obtaining a visual encoding feature of a to-be-detected image;

extracting a plurality of sets of multimodal features from the to-be-detected image, wherein each set of multimodal features comprises position information of one detection frame extracted from the to-be-detected image, a detection feature in the detection frame and first text information in the detection frame; and

obtaining second text information matched with a to-be-extracted attribute from the first text information comprised in the plurality of sets of multimodal features based on the visual encoding feature, the to-be-extracted attribute and the plurality of sets of multimodal features, wherein the to-be-extracted attribute is an attribute of text information needing to be extracted.

According to an aspect of the present disclosure, an electronic device is provided, including:

at least one processor; and

a memory in communication connection with the at least one processor; wherein

the memory stores instructions executable by the at least one processor, and the instructions are executed by the at least one processor, so as to enable the at least one processor to perform the text extraction model training method described above.

According to an aspect of the present disclosure, a non-transient computer readable storage medium storing a computer instruction is provided, wherein the computer instruction is configured to enable a computer to perform any of the methods described above.

It should be understood that the content described in this part is not intended to identify key or important features of embodiments of the present disclosure, and is not configured to limit the scope of the present disclosure as well. Other features of the present disclosure will become easily understood through the following specification.

### BRIEF DESCRIPTION OF THE DRAWINGS

Accompanying drawings are used for better understanding the present solution, and do not constitute limitation to the present disclosure. Wherein:

FIG. 1 is a flow diagram of a text extraction method provided by an embodiment of the present disclosure.

FIG. 2 is a flow diagram of a text extraction method provided by an embodiment of the present disclosure.

FIG. 3 is a flow diagram of a text extraction method provided by an embodiment of the present disclosure.

FIG. 4 is a flow diagram of a text extraction method provided by an embodiment of the present disclosure.

FIG. 5 is a flow diagram of a text extraction model training method provided by an embodiment of the present disclosure.

FIG. 6 is a flow diagram of a text extraction model training method provided by an embodiment of the present disclosure.

FIG. 7 is a flow diagram of a text extraction model training method provided by an embodiment of the present disclosure.

FIG. 8 is an example schematic diagram of a text extraction model provided by an embodiment of the present disclosure.

FIG. 9 is a schematic structural diagram of a text extraction apparatus provided by an embodiment of the present disclosure.

FIG. 10 is a schematic structural diagram of a text extraction model training apparatus provided by an embodiment of the present disclosure.

FIG. 11 is a block diagram of an electronic device for implementing a text extraction method or a text extraction model training method of an embodiment of the present disclosure.

### DETAILED DESCRIPTION

The example embodiment of the present disclosure is illustrated below with reference to the accompanying drawings, including various details of embodiments of the present disclosure for aiding understanding, and they should be regarded as being only examples. Therefore, those ordinarily skilled in the art should realize that various changes and modifications may be made on embodiments described here without departing from the scope and spirit of the present disclosure. Similarly, for clarity and simplicity, the following description omits description of a publicly known function and structure.

In the technical solution of the present disclosure, related processing such as collecting, storing, using, processing, transmitting, providing and disclosing of user personal information all conforms to provisions of relevant laws and regulations, and does not violate public order and moral.

At present, in order to generate a structured text in various scenarios, information may be extracted from an entity document and stored in a structured mode, wherein the entity document may be specifically a paper document, various notes, credentials, or cards.

At present, the commonly used modes for extracting structured information include a manual entry mode. The manual entry mode is to manually obtain information needing to be extracted from the entity document and enter it into the structured text.

Alternatively, a method based on template matching may also be adopted, that is, for credentials with a simple structure, each part of these credentials generally has a fixed geometric format, and thus a standard template can be constructed for credentials of the same structure. The standard template specifies from which geometric regions of the credentials to extract text information, after extracting the text information from a fixed position in each credential based on the standard template, the extracted text information is recognized by optical character recognition (OCR), and then the extracted text information is stored in the structured mode.

Alternatively, a method based on a key symbol search may also be adopted, that is, a search rule is set in advance, and a text is searched in a region with a specified length before or after a key symbol is specified in advance. For example, a text that meets a format of “MM-DD-YYYY” is searched after the key symbol “date”, and the searched text is taken as an attribute value of a “date” field in the structured text.

The above methods all require a lot of manual operations, that is, require manual extraction of information, or manual construction of the template for the credential of each structure, or manual setting of the search rule, which consumes a lot of manpower, and cannot be suitable for extracting the entity documents of various formats, and low in extraction efficiency.

Embodiments of the present disclosure provides a text extraction method, which can be executed by an electronic device, and the electronic device may be a smart phone, a tablet computer, a desktop computer, a server, and other devices.

The text extraction method provided by embodiments of the present disclosure is introduced in detail below.

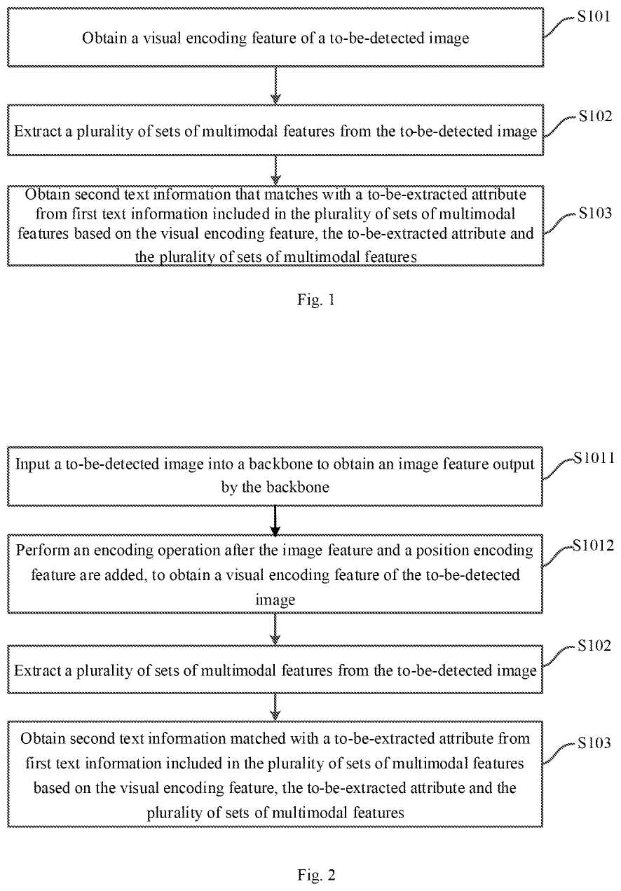

As shown in FIG. 1, an embodiment of the present disclosure provides a text extraction method. The method includes:

S101, a visual encoding feature of a to-be-detected image is obtained.

The to-be-detected image may be an image of the above entity document, such as an image of a paper document, and images of various notes, credentials or cards.

The visual encoding feature of the to-be-detected image is a feature obtained by performing feature extraction on the to-be-detected image and performing an encoding operation on the extracted feature, and a method for obtaining the visual encoding feature will be introduced in detail in subsequent embodiments.

The visual encoding feature may characterize contextual information of a text in the to-be-detected image.

S102, a plurality of sets of multimodal features are extracted from the to-be-detected image.

Each set of multimodal features includes position information of one detection frame extracted from the to-be-detected image, a detection feature in the detection frame and first text information in the detection frame.

In an embodiment of the present disclosure, the detection frame may be a rectangle, and position information of the detection frame may be represented as (x, y, w, h), where x and y represent position coordinates of any corner of the detection frame in the to-be-detected image, for example, may be position coordinates of the upper left corner of the detection frame in the to-be-detected image, and w and h represent a width and height of the detection frame respectively. For example, the position information of the detection frame is represented as (3, 5, 6, 7), then the position coordinates of the upper left corner of the detection frame in the to-be-detected image is (3, 5), the width of the detection frame is 6, and the height is 7.

Some embodiments of the present disclosure do not limit an expression form of the position information of the detection frame, and it may also be other forms capable of representing the position information of the detection frame, for example, it may further be coordinates of the four corners of the detection frame.

The detection feature in the detection frame is: a feature of the part of the image of the detection frame in the to-be-detected image.

S103, second text information matched with a to-be-extracted attribute is obtained from the first text information included in the plurality of sets of multimodal features based on the visual encoding feature, the to-be-extracted attribute and the plurality of sets of multimodal features.

The to-be-extracted attribute is an attribute of text information needing to be extracted.

For example, if the to-be-detected image is a ticket image, and the text information needing to be extracted is a station name of a starting station in a ticket, the to-be-extracted attribute is a starting station name. For example, if the station name of the starting station in the ticket is “Beijing”, then “Beijing” is the text information needing to be extracted.

Whether the first text information included in the plurality of sets of multimodal features matches with the to-be-extracted attribute may be determined through the visual encoding feature, the to-be-extracted attribute and the plurality of sets of multimodal features, so as to obtain the second text information matched with the to-be-extracted attribute.

In an embodiment of the present disclosure, the second text information matched with the to-be-extracted attribute may be obtained from the first text information included in the plurality of sets of multimodal features through the visual encoding feature and the plurality of sets of multimodal features. Because the plurality of sets of multimodal features include the plurality of first text information in the to-be-detected image, there are text information that matches with the to-be-extracted attribute and text information that does not match with the to-be-extracted attribute, and the visual encoding feature can characterize global contextual information of the text in the to-be-detected image, so the second text information that matches with the to-be-extracted attribute can be obtained from the plurality of sets of multimodal features based on the visual encoding feature. In the above process, no manual operation is required, feature extraction of the to-be-detected image is not limited to the format of the to-be-detected image, and there is no need to create the template or set the search rule for each format of entity document, which can improve the efficiency of information extraction.

In an embodiment of the present disclosure, the process of obtaining the visual encoding feature is introduced. As shown in FIG. 2, on the basis of the above embodiment, S101, obtaining the visual encoding feature of the to-be-detected image may specifically include the following steps:

S1011, the to-be-detected image is input into a backbone to obtain an image feature output by the backbone.

The backbone network, or backbone, may be a convolutional neural network (CNN), for example, may be a deep residual network (ResNet) in some implementations. In some implementations, the backbone may be a Transformer-based neural network.

Taking the Transformer-based backbone as an example, the backbone may adopt a hierarchical design, for example, the backbone may include four feature extraction layers connected in sequence, that is, the backbone can implement four feature extraction stages. Resolution of a feature map output by each feature extraction layer decreases sequentially, similar to CNN, which can expand a receptive field layer by layer.

The first feature extraction layer includes: a Token Embedding module and an encoding block (Transformer Block) in a Transformer architecture. The subsequent three feature extraction layers each include a Token Merging module and the encoding block (Transformer Block). The Token Embedding module of the first feature extraction layer may perform image segmentation and position information embedding operations. The Token Merging modules of the remaining layers mainly play a role of lower-layer sampling. The encoding blocks in each layer are configured to encode the feature, and each encoding block may include two Transformer encoders. A self-attention layer of the first Transformer encoder is a window self-attention layer, and is configured to focus attention calculation inside a fixed-size window to reduce the calculated amount. A self-attention layer in the second Transformer encoder can ensure information exchange between the different windows, thus realizing feature extraction from local to the whole, and significantly improving a feature extraction capability of the entire backbone.

S1012, an encoding operation is performed after the image feature and a position encoding feature are added, to obtain the visual encoding feature of the to-be-detected image.

The position encoding feature is obtained by performing position embedding on a preset position vector. The preset position vector may be set based on actual demands, and by adding the image feature and the position encoding feature, a visual feature that can reflect 2D spatial position information may be obtained.

In an embodiment of the present disclosure, the visual feature may be obtained by adding the image feature and the position encoding feature through a fusion network. Then the visual feature is input into one Transformer encoder or other types of encoders to be subjected to the encoding operation to obtain the visual encoding feature.

If the Transformer encoder is used for performing the encoding operation, the visual feature may be converted into a one-dimensional vector first. For example, dimensionality reduction may be performed on an addition result through a 1*1 convolution layer to meet a serialization input requirement of the Transformer encoder, and then the one-dimensional vector is input into the Transformer encoder to be subjected to the encoding operation, in this way, calculated amount of the encoder can be reduced.

It should be noted that the above S1011-S1012 may be implemented by a visual encoding sub-model included in a pre-trained text extraction model, and a process of training the text extraction model will be described in the subsequent embodiments.

By adopting the method, the image feature of the to-be-detected image may be obtained through the backbone, and then the image feature and the position encoding feature are added, which can improve a capability of the obtained visual feature to express the contextual information of the text, and improve accuracy of the subsequently obtained visual encoding feature to express the to-be-detected image, and thus improve accuracy of the subsequently extracted second text information by the visual encoding feature.

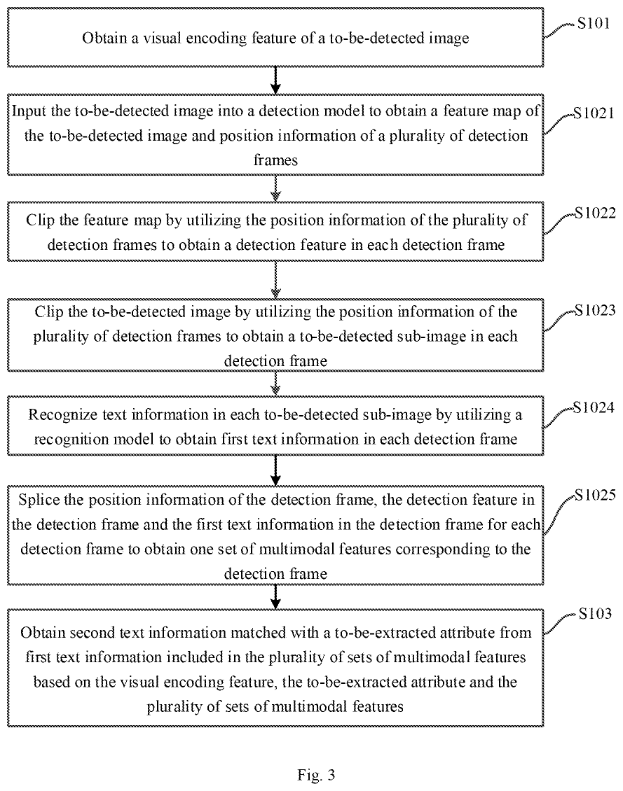

In an embodiment of the present disclosure, a process of extracting the multimodal features is introduced, wherein the multimodal features include three parts, which are the position information of the detection frame, the detection feature in the detection frame, and literal content in the detection frame. As shown in FIG. 3, the above S102, extracting the plurality of sets of multimodal features from the to-be-detected image may be specifically implemented as the following steps:

S1021, the to-be-detected image is input into a detection model to obtain a feature map of the to-be-detected image and the position information of the plurality of detection frames.

The detection model may be a model used for extracting the detection frame including the text information in an image, and the model may be an OCR model, and may also be other models in the related art, such as a neural network model, which is not limited in embodiments of the present disclosure.

After the to-be-detected image is input into the detection model, the detection model may output the feature map of the to-be-detected image and the position information of the detection frame including the text information in the to-be-detected image. An expression mode of the position information may refer to the relevant description in the above S102, which will not be repeated here.

S1022, the feature map is clipped by utilizing the position information of the plurality of detection frames to obtain the detection feature in each detection frame.

It may be understood that after obtaining the feature map of the to-be-detected image and the position information of each detection frame, the feature matched with a position of the detection frame may be cropped from the feature map based on the position information of each detection frame respectively to serve as the detection feature corresponding to the detection frame.

S1023, the to-be-detected image is clipped by utilizing the position information of the plurality of detection frames to obtain a to-be-detected sub-image in each detection frame.

Since the position information of the detection frame is configured to characterize the position of the detection frame in the to-be-detected image, an image at the position of the detection frame in the to-be-detected image can be cut out based on the position information of each detection frame, and the cut out sub-image is taken as the to-be-detected sub-image.

S1024, text information in each to-be-detected sub-image is recognized by utilizing a recognition model to obtain the first text information in each detection frame.

The recognition model may be any text recognition model, for example, may be an OCR model.

S1025, the position information of the detection frame, the detection feature in the detection frame and the first text information in the detection frame are spliced for each detection frame to obtain one set of multimodal features corresponding to the detection frame.

In an embodiment of the present disclosure, for each detection frame, the position information of the detection frame, the detection feature in the detection frame, and the first text information in the detection frame may be respectively subjected to an embedding operation, converted into a mode of the feature vector, and then are spliced, so as to obtain the multimodal feature of the detection frame.

It should be noted that the above S1021-S1025 may be implemented by a detection sub-model included in the pre-trained text extraction model, and the detection sub-model includes the above detection model and recognition model. The process of training the text extraction model will be introduced in the subsequent embodiments.

By adopting the method, the position information, detection feature and first text information of each detection frame may be accurately extracted from the to-be-detected image, so that the second text information matched with the to-be-extracted attribute is obtained subsequently from the extracted first text information. Because the multimodal feature extraction in an embodiment of the present disclosure does not depend on the position specified by the template or a keyword position, even if the first text information in the to-be-detected image has problems such as distortion and printing offset, the multimodal features can also be accurately extracted from the to-be-detected image.

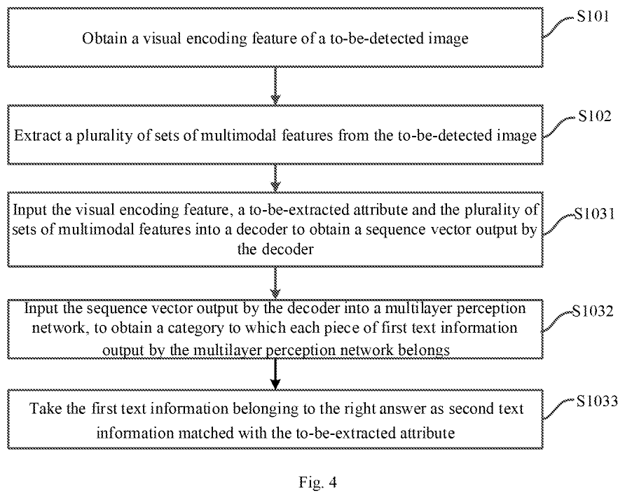

In an embodiment of the present disclosure, as shown in FIG. 4, S103 may be implemented as:

S1031, the visual encoding feature, the to-be-extracted attribute and the plurality of sets of multimodal features are input into a decoder to obtain a sequence vector output by the decoder.

The decoder may be a Transformer decoder, and the decoder includes a self-attention layer and an encoding-decoding attention layer. S1031 may be specifically implemented as:

Step 1, the to-be-extracted attribute and the plurality of sets of multimodal features are input into a self-attention layer of the decoder to obtain a plurality of fusion features. Each fusion feature is a feature obtained by fusing one set of multimodal features with the to-be-extracted attribute.

In an embodiment of the present disclosure, the multimodal features may serve multimodal queries in a Transformer network, and the to-be-extracted attribute may serve as key query. The to-be-extracted attribute may be input into the self-attention layer of the decoder after being subjected to the embedding operation, and the plurality of sets of multimodal features may be input into the self-attention layer, thus the self-attention layer may fuse each set of multimodal features with the to-be-extracted attribute respectively to output the fusion feature corresponding to each set of multimodal features.

The key query is fused into the multimodal feature queries through the self-attention layer, so that the Transformer network can understand the key query and the first text information (value) in the multimodal feature at the same time, so as to understand a relationship between the key-value.

Step 2, the plurality of fusion features and the visual encoding feature are input into the encoding-decoding attention layer of the decoder to obtain the sequence vector output by the encoding-decoding attention layer.

Through the fusion of the to-be-extracted attribute and the multimodal features through a self-attention mechanism, association between the to-be-extracted attribute and the first text information included in the plurality of sets of multimodal features is obtained. At the same time, the attention mechanism of the Transformer decoder obtains the visual encoding feature characterizing the contextual information of the to-be-detected image, and then the decoder may obtain the relationship between the multimodal features and the to-be-extracted attribute based on the visual encoding feature, that is, the sequence vector can reflect the relationship between each set of multimodal features and the to-be-extracted attribute, so that the subsequent multilayer perception network can accurately determine a category of each set of multimodal features based on the sequence vector.

S1032, the sequence vector output by the decoder is input into a multilayer perception network, to obtain the category to which each piece of first text information output by the multilayer perception network belongs.

The category output by the multilayer perception network includes a right answer and a wrong answer. The right answer represents that an attribute of the first text information in the multimodal feature is the to-be-extracted attribute, and the wrong answer represents that the attribute of the first text information in the multimodal features is not the to-be-extracted attribute.

The multilayer perception network in an embodiment of the present disclosure is a multilayer perceptron (MLP) network. The MLP network can specifically output the category of each set of multimodal queries, that is, if the category of one set of multimodal queries output by the MLP is right answer, it means that the first text information included in the set of multimodal queries is the to-be-extracted second text information; and if the category of one set of multimodal queries output by the MLP is wrong answer, it means that the first text information included in the set of multimodal queries is not the to-be-extracted second text information.

It should be noted that both the decoder and the multilayer perception network in an embodiment of the present disclosure have been trained, and the specific training method will be described in the subsequent embodiments.

S1033, first text information belonging to the right answer is taken as the second text information matched with the to-be-extracted attribute.

It should be noted that the above S1031-S1033 may be implemented by an output sub-model included in the pre-trained text extraction model, and the output sub-model includes the above decoder and multilayer perception network. The process of training the text extraction model will be introduced in the subsequent embodiments.

In an embodiment of the present disclosure, the plurality of sets of multimodal features, the to-be-extracted attribute, and the visual encoding feature are decoded through the attention mechanism in the decoder to obtain the sequence vector. Furthermore, the multilayer perception network may output the category of each piece of first text information according to the sequence vector, and determines the first text information of the right answer as the second text information matched with the to-be-extracted attribute, which realizes the text extraction of credentials and notes of various formats, saves labor cost, and can improve the extraction efficiency.

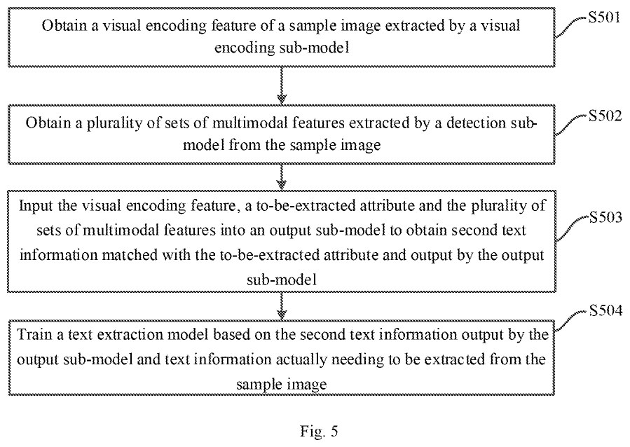

Based on the same technical concept, an embodiment of the present disclosure further provides a text extraction model training method. A text extraction model includes a visual encoding sub-model, a detection sub-model and an output sub-model, and as shown in FIG. 5, the method includes:

S501, a visual encoding feature of a sample image extracted by the visual encoding sub-model is obtained.

The sample image is an image of the above entity document, such as an image of a paper document, and images of various notes, credentials or cards.

The visual encoding feature may characterize contextual information of a text in the sample image.

S502, a plurality of sets of multimodal features extracted by the detection sub-model from the sample image are obtained.

Each set of multimodal features includes position information of one detection frame extracted from the sample image, a detection feature in the detection frame and first text information in the detection frame.

The position information of the detection frame and the detection feature in the detection frame may refer to the relevant description in the above S102, which will not be repeated here.

S503, the visual encoding feature, a to-be-extracted attribute and the plurality of sets of multimodal features are input into the output sub-model to obtain second text information matched with the to-be-extracted attribute and output by the output sub-model.

The to-be-extracted attribute is an attribute of text information needing to be extracted.

For example, the sample image is a ticket image, and the text information needing to be extracted is a station name of a starting station in a ticket, thus the to-be-extracted attribute is a starting station name. For example, if the station name of the starting station in the ticket is “Beijing”, then “Beijing” is the text information needing to be extracted.

S504, the text extraction model is trained based on the second text information output by the output sub-model and text information actually needing to be extracted from the sample image.

In an embodiment of the present disclosure, a label of the sample image is the text information actually needing to be extracted from the sample image. A loss function value may be calculated based on the second text information matched with the to-be-extracted attribute and the text information actually needing to be extracted in the sample image, parameters of the text extraction model are adjusted according to the loss function value, and whether the text extraction model is converged is judged. If it is not converged, S501-S503 are continued to be executed based on the next sample image, and the loss function value is calculated again until the text extraction model is determined to converge based on the loss function value, and the trained text extraction model is obtained.

In an embodiment of the present disclosure, the text extracting model may obtain the second text information matched with the to-be-extracted attribute from the first text information included in the plurality of sets of multimodal features through the visual encoding feature of the sample image and the plurality of sets of multimodal features. Because the plurality of sets of multimodal features include the plurality of first text information in the to-be-detected image, there are the text information matched with the to-be-extracted attribute and text information that is not matched with the to-be-extracted attribute, and the visual encoding feature can characterize global contextual information of the text in the to-be-detected image, so the text extraction model may obtain the second text information matched with the to-be-extracted attribute from the plurality of sets of multimodal features based on the visual encoding feature. After the text extraction model is trained, the second text information can be extracted directly through the text extraction model without manual operation, and is not limited by a format of an entity document that needs to be subjected to text information extraction, which can improve information extraction efficiency.

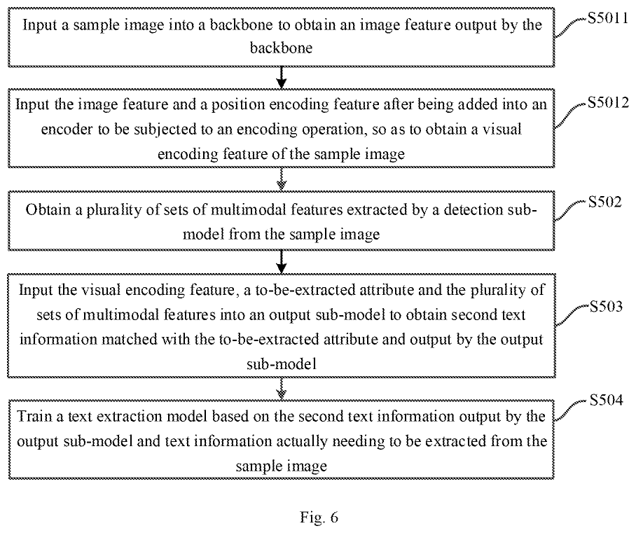

In an embodiment of the present disclosure, the above visual encoding sub-model includes a backbone and an encoder. As shown in FIG. 6, the S501 includes the following steps:

S5011, the sample image is input into the backbone to obtain an image feature output by the backbone.

The backbone contained in the visual encoding sub-model is the same as the backbone described in the above embodiment, and reference may be made to the relevant description about the backbone in the above embodiment, which will not be repeated here.

S5012, the image feature and a position encoding feature after being added are input into the encoder to be subjected to an encoding operation, so as to obtain the visual encoding feature of the sample image.

Processing of the image feature of the sample image in this step is the same as the processing process of the image feature of the to-be-detected image in above S1012, and may refer to relevant description in above S1012, and which is not repeated here.

In an embodiment, the image feature of the to-be-detected image may be obtained through the backbone of the visual encoding sub-model, and then the image feature and the position encoding feature are added, which can improve a capability of the obtained visual feature to express the contextual information of the text, and improve accuracy of the visual encoding feature subsequently obtained by the encoder to express the to-be-detected image, and thus improve accuracy of the subsequently extracted second text information by the visual encoding feature.

In an embodiment of the present disclosure, the above detection sub-model includes a detection model and a recognition model. On this basis, the above S502, obtaining the plurality of sets of multimodal features extracted by the detection sub-model from the sample image may be specifically implemented as the following steps:

step 1, the sample image is input into the detection model to obtain a feature map of the sample image and the position information of the plurality of detection frames.

Step 2, the feature map is clipped by utilizing the position information of the plurality of detection frames to obtain the detection feature in each detection frame.

Step 3, the sample image is clipped by utilizing the position information of the plurality of detection frames to obtain a sample sub-image in each detection frame.

Step 4, the first text information in each sample sub-image is recognized by utilizing the recognition model to obtain the first text information in each detection frame.

Step 5, the position information of the detection frame, the detection feature in the detection frame and the first text information in the detection frame are spliced for each detection frame to obtain one set of multimodal features corresponding to the detection frame.

The method for extracting the plurality of sets of multimodal features from the sample image in the above step 1 to step 5 is the same as the method for extracting the multimodal features from the to-be-detected image described in an embodiment corresponding to FIG. 3, and may refer to the relevant description in the above embodiment, which is not repeated here.

In an embodiment, the position information, detection feature and first text information of each detection frame may be accurately extracted from the sample image by using the trained detection sub-model, so that the second text information matched with the to-be-extracted attribute is obtained subsequently from the extracted first text information. Because the multimodal feature extraction in an embodiment of the present disclosure does not depend on the position specified by the template or a keyword position, even if the first text information in the to-be-detected image has problems such as distortion and printing offset, the multimodal features can also be accurately extracted from the to-be-detected image.

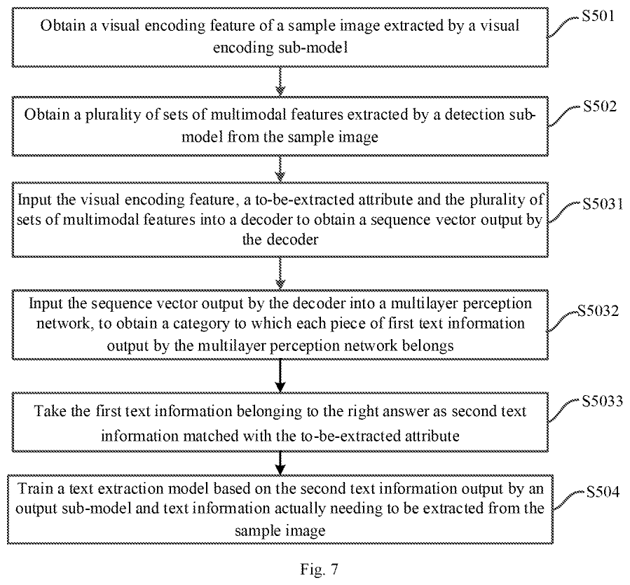

In an embodiment of the present disclosure, the output sub-model includes a decoder and a multilayer perception network. As shown in FIG. 7, S503 may include the following steps:

S5031, the visual encoding feature, the to-be-extracted attribute and the plurality of sets of multimodal features are input into the decoder to obtain a sequence vector output by the decoder.

The decoder includes a self-attention layer and an encoding-decoding attention layer. S5031 may be implemented as:

The to-be-extracted attribute and the plurality of sets of multimodal features are input into the self-attention layer to obtain a plurality of fusion features. Then the plurality of fusion features and the visual encoding feature are input into the encoding-decoding attention layer to obtain the sequence vector output by the encoding-decoding attention layer. Each fusion feature is a feature obtained by fusing one set of multimodal features with the to-be-extracted attribute.

Through the fusion of the to-be-extracted attribute and the multimodal features through a self-attention mechanism, association between the to-be-extracted attribute and the first text information included in the plurality of sets of multimodal features is obtained. At the same time, the attention mechanism of the Transformer decoder obtains the visual encoding feature characterizing the contextual information of the to-be-detected image, and then the decoder may obtain the relationship between the multimodal features and the to-be-extracted attribute based on the visual encoding feature, that is, the sequence vector can reflect the relationship between each set of multimodal features and the to-be-extracted attribute, so that the subsequent multilayer perception network can accurately determine a category of each set of multimodal features based on the sequence vector.

S5032, the sequence vector output by the decoder is input into a multilayer perception network, to obtain the category to which each piece of first text information output by the multilayer perception network belongs.

The category output by the multilayer perception network includes a right answer and a wrong answer. The right answer represents that an attribute of the first text information in the multimodal feature is the to-be-extracted attribute, and the wrong answer represents that the attribute of the first text information in the multimodal features is not the to-be-extracted attribute.

S5033, first text information belonging to the right answer is taken as the second text information matched with the to-be-extracted attribute.

In an embodiment of the present disclosure, the plurality of sets of multimodal features, the to-be-extracted attribute, and the visual encoding feature are decoded through the attention mechanism in the decoder to obtain the sequence vector. Furthermore, the multilayer perception network may output the category of each piece of first text information according to the sequence vector, and determines the first text information of the right answer as the second text information matched with the to-be-extracted attribute, which realizes the text extraction of credentials and notes of various formats, saves labor cost, and can improve the extraction efficiency.

The text extraction method provided by embodiments of the present disclosure is described below with reference to the text extraction model shown in FIG. 8. Taking the to-be-detected image being a train ticket as an example, as shown in FIG. 8, the plurality of sets of multimodal features queries can be extracted from the to-be-detected image. The multimodal features include position information Bbox (x, y, w, h) of the detection frame, the detection features and the first text information (Text).

In an embodiment of the present disclosure, the to-be-extracted attribute originally taken as key is taken as query, and the to-be-extracted attribute may be called Key Query. As an example, the to-be-extracted attribute may specifically be a starting station.

The to-be-detected image (Image) is input into the backbone to extract the image feature, the image feature is subjected to position embedding and converted into a one-dimensional vector.

The one-dimensional vector is input into the Transformer Encoder for encoding, and the visual encoding feature is obtained.

The visual encoding feature, the multimodal feature queries and the to-be-extracted attribute (Key Query) are input into the Transformer Decoder to obtain the sequence vector.

The sequence vector is input into the MLP to obtain the category of the first text information contained in each multimodal feature, and the category is the right answer (or called Right Value) or the wrong answer (or called Wrong Value).

The first text information being the right answer indicates that the attribute of the first text information is the to-be-extracted attribute, the first text information is the text to be extracted, in FIG. 8, the to-be-extracted attribute is the starting station, and the category of Chinese term “ [symbol] ” is the right answer, and Chinese term “ [symbol] ” is the second text information to be extracted.

In an embodiment of the present disclosure, by defining the key (the to-be-extracted attribute) as Query, and inputting it into the self-attention layer of the Transformer decoder, each set of multimodal feature Queries is fused with the to-be-extracted attribute respectively, that is, the relationship between the multimodal features and the to-be-extracted attribute is established by utilizing the Transformer encoder. Then, the encoding-decoding attention layer of the Transformer encoder is utilized to realize the fusion of the multimodal features, the to-be-extracted attribute and the visual encoding feature, so that finally, MLP can output the value answers corresponding to the key query and realize end-to-end structured information extraction. Through a mode of defining the key-value as question-answer, the training of the text extraction model can be compatible with credentials and notes of different formats, and the text extraction model obtained by training can accurately perform structured text extraction on the credentials and notes of various fixed formats and non-fixed formats, thereby expanding a business scope of note recognition, being capable of resist the influence of factors such as note distortion and printing offset, and accurately extracting the specific text information.

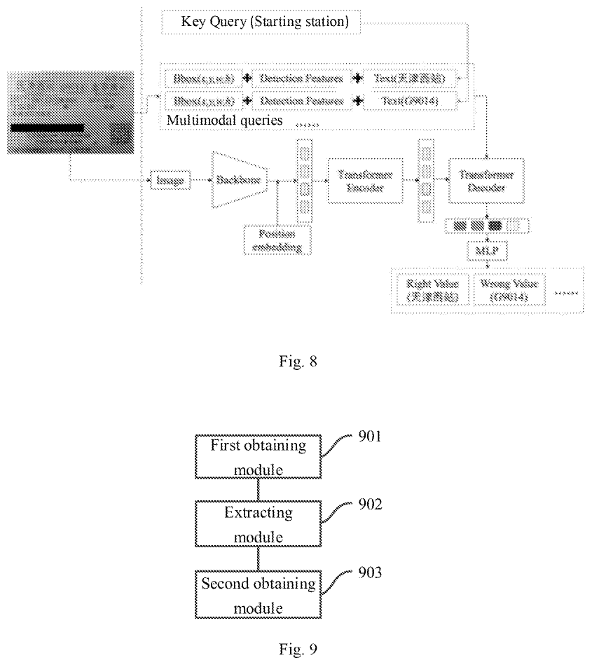

Corresponding to method embodiments described herein, as shown in FIG. 9, an embodiment of the present disclosure further provides a text extraction apparatus, including:

a first obtaining module 901, configured to obtain a visual encoding feature of a to-be-detected image;

an extracting module 902, configured to extract a plurality of sets of multimodal features from the to-be-detected image, wherein each set of multimodal features includes position information of one detection frame extracted from the to-be-detected image, a detection feature in the detection frame and first text information in the detection frame; and

a second obtaining module 903, configured to obtain second text information matched with a to-be-extracted attribute from the first text information included in the plurality of sets of multimodal features based on the visual encoding feature, the to-be-extracted attribute and the plurality of sets of multimodal features, wherein the to-be-extracted attribute is an attribute of text information needing to be extracted.

In an embodiment of the present disclosure, the second obtaining module 903 is specifically configured to:

input the visual encoding feature, the to-be-extracted attribute and the plurality of sets of multimodal features into a decoder to obtain a sequence vector output by the decoder;

input the sequence vector output by the decoder into a multilayer perception network, to obtain a category to which each piece of first text information output by the multilayer perception network belongs, wherein the category output by the multilayer perception network includes a right answer and a wrong answer; and

take the first text information belonging to the right answer as the second text information matched with the to-be-extracted attribute.

In an embodiment of the present disclosure, the second obtaining module 903 is specifically configured to:

input the to-be-extracted attribute and the plurality of sets of multimodal features into a self-attention layer of the decoder to obtain a plurality of fusion features, wherein each fusion feature is a feature obtained by fusing one set of multimodal features with the to-be-extracted attribute; and

input the plurality of fusion features and the visual encoding feature into an encoding-decoding attention layer of the decoder to obtain the sequence vector output by the encoding-decoding attention layer.

In an embodiment of the present disclosure, the first obtaining module 901 is specifically configured to:

input the to-be-detected image into a backbone to obtain an image feature output by the backbone; and

perform an encoding operation after the image feature and a position encoding feature are added, to obtain the visual encoding feature of the to-be-detected image.

In an embodiment of the present disclosure, the extracting module 902 is specifically configured to:

input the to-be-detected image into a detection model to obtain a feature map of the to-be-detected image and the position information of the plurality of detection frames;

clip the feature map by utilizing the position information of the plurality of detection frames to obtain the detection feature in each detection frame;

clip the to-be-detected image by utilizing the position information of the plurality of detection frames to obtain a to-be-detected sub-image in each detection frame;

recognize text information in each to-be-detected sub-image by utilizing a recognition model to obtain the first text information in each detection frame; and

splice the position information of the detection frame, the detection feature in the detection frame and the first text information in the detection frame for each detection frame to obtain one set of multimodal features corresponding to the detection frame.

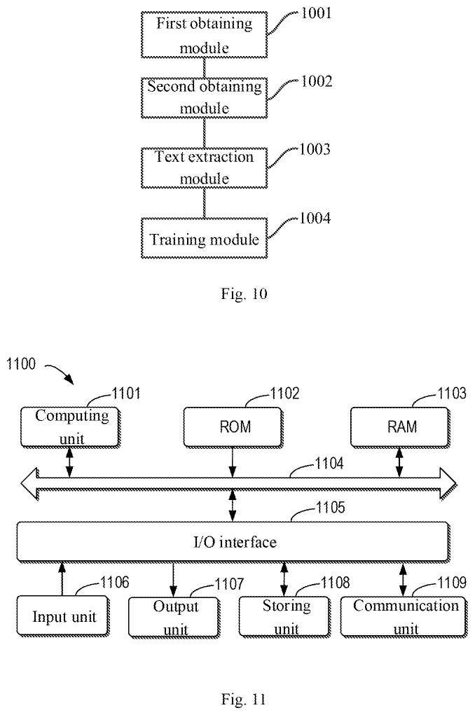

Corresponding to method embodiments described herein, an embodiment of the present disclosure further provides a text extraction model training apparatus. A text extraction model includes a visual encoding sub-model, a detection sub-model and an output sub-model. As shown in FIG. 10, the apparatus includes:

a first obtaining module 1001, configured to obtain a visual encoding feature of a sample image extracted by the visual encoding sub-model;

a second obtaining module 1002, configured to obtain a plurality of sets of multimodal features extracted by the detection sub-model from the sample image, wherein each set of multimodal features includes position information of one detection frame extracted from the sample image, a detection feature in the detection frame and first text information in the detection frame;

a text extracting module 1003, configured to input the visual encoding feature, a to-be-extracted attribute and the plurality of sets of multimodal features into the output sub-model to obtain second text information matched with the to-be-extracted attribute and output by the output sub-model, wherein the to-be-extracted attribute is an attribute of text information needing to be extracted; and

a training module 1004, configured to train the text extraction model based on the second text information output by the output sub-model and text information actually needing to be extracted from the sample image.

In an embodiment of the present disclosure, the output sub-model includes a decoder and a multilayer perception network. The text extraction module 1003 is specifically configured to:

input the visual encoding feature, the to-be-extracted attribute and the plurality of sets of multimodal features into a decoder to obtain a sequence vector output by the decoder;

input the sequence vector output by the decoder into a multilayer perception network, to obtain a category to which each piece of first text information output by the multilayer perception network belongs, wherein the category output by the multilayer perception network includes a right answer and a wrong answer; and

take the first text information belonging to the right answer as the second text information matched with the to-be-extracted attribute.

In an embodiment of the present disclosure, the decoder includes a self-attention layer and an encoding-decoding attention layer, and the text extracting module 1003 is specifically configured to:

input the to-be-extracted attribute and the plurality of sets of multimodal features into the self-attention layer to obtain a plurality of fusion features, wherein each fusion feature is a feature obtained by fusing one set of multimodal features with the to-be-extracted attribute; and

input the plurality of fusion features and the visual encoding feature into the encoding-decoding attention layer to obtain the sequence vector output by the encoding-decoding attention layer.

In an embodiment of the present disclosure, the visual encoding sub-model includes a backbone and an encoder, and the first obtaining module 1001 is specifically configured to:

input the sample image into the backbone to obtain an image feature output by the backbone; and

input the image feature and a position encoding feature after being added into the encoder to be subjected to an encoding operation, so as to obtain the visual encoding feature of the sample image.

In an embodiment of the present disclosure, the detection sub-model includes a detection model and a recognition model, and the second obtaining module 1002 is specifically configured to:

input the sample image into the detection model to obtain a feature map of the sample image and the position information of the plurality of detection frames;

clip the feature map by utilizing the position information of the plurality of detection frames to obtain the detection feature in each detection frame;

clip the sample image by utilizing the position information of the plurality of detection frames to obtain a sample sub-image in each detection frame;

recognize text information in each sample sub-image by utilizing the recognition model to obtain the text information in each detection frame; and

splice the position information of the detection frame, the detection feature in the detection frame and the first text information in the detection frame for each detection frame to obtain one set of multimodal features corresponding to the detection frame.

According to embodiments of the present disclosure, the present disclosure further provides an electronic device, a readable storage medium and a computer program product.

FIG. 11 shows a schematic block diagram of an example electronic device 1100 capable of being used for implementing embodiments of the present disclosure. The electronic device aims to express various forms of digital computers, such as a laptop computer, a desk computer, a work bench, a personal digital assistant, a server, a blade server, a mainframe computer and other proper computers. The electronic device may further express various forms of mobile apparatuses, such as a personal digital assistant, a cellular phone, an intelligent phone, a wearable device and other similar computing apparatuses. Parts shown herein, their connection and relations, and their functions only serve as an example, and are not intended to limit implementation of the present disclosure described and/or required herein.

As shown in FIG. 11, the device 1100 includes a computing unit 1101, which may execute various proper motions and processing according to a computer program stored in a read-only memory (ROM) 1102 or a computer program loaded from a storing unit 1108 to a random access memory (RAM) 1103. In the RAM 1103, various programs and data required by operation of the device 1100 may further be stored. The computing unit 1101, the ROM 1102 and the RAM 1103 are connected with one another through a bus 1104. An input/output (I/O) interface 1105 is also connected to the bus 1104.

A plurality of parts in the device 1100 are connected to the I/O interface 1105, including: an input unit 1106 such as a keyboard and a mouse; an output unit 1107, such as various types of displays and speakers; the storing unit 1108, such as a magnetic disc and an optical disc; and a communication unit 1109, such as a network card, a modem, and a wireless communication transceiver. The communication unit 1109 allows the device 1100 to exchange information/data with other devices through a computer network such as Internet and/or various telecommunication networks.

The computing unit 1101 may be various general and/or dedicated processing components with processing and computing capabilities. Some examples of the computing unit 1101 include but not limited to a central processing unit (CPU), a graphic processing unit (GPU), various dedicated artificial intelligence (AI) computing chips, various computing units running a machine learning model algorithm, a digital signal processor (DSP), and any proper processor, controller, microcontroller, etc. The computing unit 1101 executes all the methods and processing described above, such as the text extraction method or the text extraction model training method. For example, in some embodiments, the text extraction method or the text extraction model training method may be implemented as a computer software program, which is tangibly contained in a machine readable medium, such as the storing unit 1108. In some embodiments, part or all of the computer program may be loaded into and/or mounted on the device 1100 via the ROM 1102 and/or the communication unit 1109. When the computer program is loaded to the RAM 1103 and executed by the computing unit 1101, one or more steps of the text extraction method or the text extraction model training method described above may be executed. Alternatively, in other embodiments, the computing unit 1101 may be configured to execute the text extraction method or the text extraction model training method through any other proper modes (for example, by means of firmware).

Various implementations of the systems and technologies described above in this paper may be implemented in a digital electronic circuit system, an integrated circuit system, a field programmable gate array (FPGA), an application specific integrated circuit (ASIC), an application specific standard part (ASSP), a system on chip (SOC), a complex programmable logic device (CPLD), computer hardware, firmware, software and/or their combinations. These various implementations may include: being implemented in one or more computer programs, wherein the one or more computer programs may be executed and/or interpreted on a programmable system including at least one programmable processor, and the programmable processor may be a special-purpose or general-purpose programmable processor, and may receive data and instructions from a storage system, at least one input apparatus, and at least one output apparatus, and transmit the data and the instructions to the storage system, the at least one input apparatus, and the at least one output apparatus.

Program codes for implementing the methods of the present disclosure may be written in any combination of one or more programming languages. These program codes may be provided to processors or controllers of a general-purpose computer, a special-purpose computer or other programmable data processing apparatuses, so that when executed by the processors or controllers, the program codes enable the functions/operations specified in the flow diagrams and/or block diagrams to be implemented. The program codes may be executed completely on a machine, partially on the machine, partially on the machine and partially on a remote machine as a separate software package, or completely on the remote machine or server.

In the context of the present disclosure, a machine readable medium may be a tangible medium that may contain or store a program for use by or in connection with an instruction execution system, apparatus or device. The machine readable medium may be a machine readable signal medium or a machine readable storage medium. The machine readable medium may include but not limited to an electronic, magnetic, optical, electromagnetic, infrared, or semiconductor system, apparatus or device, or any suitable combination of the above contents. More specific examples of the machine readable storage medium will include electrical connections based on one or more lines, a portable computer disk, a hard disk, a random access memory (RAM), a read only memory (ROM), an erasable programmable read only memory (EPROM or flash memory), an optical fiber, a portable compact disk read only memory (CD-ROM), an optical storage device, a magnetic storage device, or any suitable combination of the above contents.

In order to provide interactions with users, the systems and techniques described herein may be implemented on a computer, and the computer has: a display apparatus for displaying information to the users (e.g., a CRT (cathode ray tube) or LCD (liquid crystal display) monitor); and a keyboard and a pointing device (e.g., a mouse or trackball), through which the users may provide input to the computer. Other types of apparatuses may further be used to provide interactions with users; for example, feedback provided to the users may be any form of sensory feedback (e.g., visual feedback, auditory feedback, or tactile feedback); an input from the users may be received in any form (including acoustic input, voice input or tactile input).

The systems and techniques described herein may be implemented in a computing system including background components (e.g., as a data server), or a computing system including middleware components (e.g., an application server) or a computing system including front-end components (e.g., a user computer with a graphical user interface or a web browser through which a user may interact with the implementations of the systems and technologies described herein), or a computing system including any combination of such background components, middleware components, or front-end components. The components of the system may be interconnected by digital data communication (e.g., a communication network) in any form or medium. Examples of the communication network include: a local area network (LAN), a wide area network (WAN) and the Internet.

A computer system may include a client and a server. The client and the server are generally away from each other and usually interact through the communication network. A relationship of the client and the server is generated through computer programs run on a corresponding computer and mutually having a client-server relationship. The server may be a cloud server or a server of a distributed system, or a server in combination with a blockchain.

It should be understood that various forms of flows shown above may be used to reorder, increase or delete the steps. For example, all the steps recorded in the present disclosure may be executed in parallel, may also be executed sequentially or in different sequences, as long as the expected result of the technical solution disclosed by the present disclosure may be implemented, which is not limited herein.

The above specific implementation does not constitute the limitation to the protection scope of the present disclosure. It should be understood by those skilled in the art that various modifications, combinations, sub-combinations and substitutions may be made according to design requirements and other factors. Any modification, equivalent substitution, improvement and the like made within the spirit and principle of the present disclosure shall all be contained in the protection scope of the present disclosure.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

What is claims is:

1. A text extraction method, comprising:
obtaining a visual encoding feature of a to-be-detected image;
extracting a plurality of sets of multimodal features from the to-be-detected image, wherein each set of multimodal features comprise position information of a detection frame extracted from the to-be-detected image, a detection feature in the detection frame and first text information in the detection frame; and
obtaining second text information that matches with a to-be-extracted attribute from the first text information comprised in the plurality of sets of multimodal features based on the visual encoding feature, the to-be-extracted attribute and the plurality of sets of multimodal features, wherein the to-be-extracted attribute is an attribute of text information needing to be extracted.

2. The method according to claim 1, wherein the obtaining the second text information matched with the to-be-extracted attribute from the first text information comprised in the plurality of sets of multimodal features based on the visual encoding feature, the to-be-extracted attribute, and the plurality of sets of multimodal features comprises:
inputting the visual encoding feature, the to-be-extracted attribute and the plurality of sets of multimodal features into a decoder to obtain a sequence vector output by the decoder;
inputting the sequence vector output by the decoder into a multilayer perception network, to obtain a category to which each piece of first text information output by the multilayer perception network belongs, wherein the category output by the multilayer perception network comprises a right answer and a wrong answer; and
taking the first text information belonging to the right answer as the second text information matched with the to-be-extracted attribute.

3. The method according to claim 2, wherein the inputting the visual encoding feature, the to-be-extracted attribute and the plurality of sets of multimodal features into the decoder to obtain the sequence vector output by the decoder comprises:
inputting the to-be-extracted attribute and the plurality of sets of multimodal features into a self-attention layer of the decoder to obtain a plurality of fusion features, wherein each fusion feature is a feature obtained by fusing one set of multimodal features with the to-be-extracted attribute; and
inputting the plurality of fusion features and the visual encoding feature into an encoding-decoding attention layer of the decoder to obtain the sequence vector output by the encoding-decoding attention layer.

4. The method according to claim 1, wherein the obtaining the visual encoding feature of the to-be-detected image comprises:
inputting the to-be-detected image into a backbone network to obtain an image feature output by the backbone network; and
performing an encoding operation after the image feature and a position encoding feature are added, to obtain the visual encoding feature of the to-be-detected image.

5. The method according to claim 1, wherein the extracting the plurality of sets of multimodal features from the to-be-detected image comprises:
inputting the to-be-detected image into a detection model to obtain a feature map of the to-be-detected image and the position information of the plurality of detection frames;
clipping the feature map by utilizing the position information of the plurality of detection frames to obtain the detection feature in each detection frame;
clipping the to-be-detected image by utilizing the position information of the plurality of detection frames to obtain a to-be-detected sub-image in each detection frame;
recognizing text information in each to-be-detected sub-image by utilizing a recognition model to obtain the first text information in each detection frame; and
splicing the position information of the detection frame, the detection feature in the detection frame and the first text information in the detection frame for each detection frame to obtain one set of multimodal features corresponding to the detection frame.

6. A text extraction model training method, wherein a text extraction model comprises a visual encoding sub-model, a detection sub-model and an output sub-model, and the method comprises:
obtaining a visual encoding feature of a sample image extracted by the visual encoding sub-model;
obtaining a plurality of sets of multimodal features extracted by the detection sub-model from the sample image, wherein each set of multimodal features comprise position information of a detection frame extracted from the sample image, a detection feature in the detection frame and first text information in the detection frame;
inputting the visual encoding feature, a to-be-extracted attribute and the plurality of sets of multimodal features into the output sub-model to obtain second text information that matches with the to-be-extracted attribute and output by the output sub-model, wherein the to-be-extracted attribute is an attribute of text information needing to be extracted; and
training the text extraction model based on the second text information output by the output sub-model and text information actually needing to be extracted from the sample image.

7. The method according to claim 6, wherein the output sub-model comprises a decoder and a multilayer perception network, and the inputting the visual encoding feature, the to-be-extracted attribute and the plurality of sets of multimodal features into the output sub-model to obtain the second text information matched with the to-be-extracted attribute and output by the output sub-model comprises:
inputting the visual encoding feature, the to-be-extracted attribute and the plurality of sets of multimodal features into the decoder to obtain a sequence vector output by the decoder;
inputting the sequence vector output by the decoder into the multilayer perception network, to obtain a category to which each piece of first text information output by the multilayer perception network belongs, wherein the category output by the multilayer perception network comprises a right answer and a wrong answer; and
taking the first text information belonging to the right answer as the second text information matched with the to-be-extracted attribute.

8. The method according to claim 7, wherein the decoder comprises a self-attention layer and an encoding-decoding attention layer, and the inputting the visual encoding feature, the to-be-extracted attribute and the plurality of sets of multimodal features into the decoder to obtain the sequence vector output by the decoder comprises:
inputting the to-be-extracted attribute and the plurality of sets of multimodal features into the self-attention layer to obtain a plurality of fusion features, wherein each fusion feature is a feature obtained by fusing one set of multimodal features with the to-be-extracted attribute; and
inputting the plurality of fusion features and the visual encoding feature into the encoding-decoding attention layer to obtain the sequence vector output by the encoding-decoding attention layer.

9. The method according to claim 6, wherein the visual encoding sub-model comprises a backbone network and an encoder, and the obtaining the visual encoding feature of the sample image extracted by the visual encoding sub-model comprises:
inputting the sample image into the backbone network to obtain an image feature output by the backbone network; and
inputting the image feature and a position encoding feature into the encoder to be subjected to an encoding operation, so as to obtain the visual encoding feature of the sample image.

10. The method according to claim 6, wherein the detection sub-model comprises a detection model and a recognition model, and the obtaining the plurality of sets of multimodal features extracted by the detection sub-model from the sample image comprises:
inputting the sample image into the detection model to obtain a feature map of the sample image and the position information of the plurality of detection frames;
clipping the feature map by utilizing the position information of the plurality of detection frames to obtain the detection feature in each detection frame;
clipping the sample image by utilizing the position information of the plurality of detection frames to obtain a sample sub-image in each detection frame;
recognizing text information in each sample sub-image by utilizing the recognition model to obtain the first text information in each detection frame; and
splicing the position information of the detection frame, the detection feature in the detection frame and the first text information in the detection frame for each detection frame to obtain one set of multimodal features corresponding to the detection frame.

11. An electronic device, comprising:
at least one processor; and
a memory in communication connection with the at least one processor; wherein
the memory stores instructions executable by the at least one processor, and the instructions are executed by the at least one processor, so as to enable the at least one processor to perform operations including:
obtaining a visual encoding feature of a to-be-detected image;
extracting a plurality of sets of multimodal features from the to-be-detected image, wherein each set of multimodal features comprises position information of a detection frame extracted from the to-be-detected image, a detection feature in the detection frame and first text information in the detection frame; and
obtaining second text information that matches with a to-be-extracted attribute from the first text information comprised in the plurality of sets of multimodal features based on the visual encoding feature, the to-be-extracted attribute and the plurality of sets of multimodal features, wherein the to-be-extracted attribute is an attribute of text information needing to be extracted.

12. The electronic device according to claim 11, wherein the obtaining the second text information matched with the to-be-extracted attribute from the first text information comprised in the plurality of sets of multimodal features based on the visual encoding feature, the to-be-extracted attribute and the plurality of sets of multimodal features comprises:
inputting the visual encoding feature, the to-be-extracted attribute and the plurality of sets of multimodal features into a decoder to obtain a sequence vector output by the decoder;
inputting the sequence vector output by the decoder into a multilayer perception network, to obtain a category to which each piece of first text information output by the multilayer perception network belongs, wherein the category output by the multilayer perception network comprises a right answer and a wrong answer; and
taking the first text information belonging to the right answer as the second text information matched with the to-be-extracted attribute.

13. The electronic device according to claim 12, wherein the inputting the visual encoding feature, the to-be-extracted attribute and the plurality of sets of multimodal features into the decoder to obtain the sequence vector output by the decoder comprises:
inputting the to-be-extracted attribute and the plurality of sets of multimodal features into a self-attention layer of the decoder to obtain a plurality of fusion features, wherein each fusion feature is a feature obtained by fusing one set of multimodal features with the to-be-extracted attribute; and
inputting the plurality of fusion features and the visual encoding feature into an encoding-decoding attention layer of the decoder to obtain the sequence vector output by the encoding-decoding attention layer.

14. The electronic device according to claim 11, wherein the obtaining the visual encoding feature of the to-be-detected image comprises:
inputting the to-be-detected image into a backbone network to obtain an image feature output by the backbone network; and
performing an encoding operation after the image feature and a position encoding feature are added, to obtain the visual encoding feature of the to-be-detected image.

15. The electronic device according to claim 11, wherein the extracting the plurality of sets of multimodal features from the to-be-detected image comprises:
inputting the to-be-detected image into a detection model to obtain a feature map of the to-be-detected image and the position information of the plurality of detection frames;
clipping the feature map by utilizing the position information of the plurality of detection frames to obtain the detection feature in each detection frame;
clipping the to-be-detected image by utilizing the position information of the plurality of detection frames to obtain a to-be-detected sub-image in each detection frame;
recognizing text information in each to-be-detected sub-image by utilizing a recognition model to obtain the first text information in each detection frame; and
splicing the position information of the detection frame, the detection feature in the detection frame and the first text information in the detection frame for each detection frame to obtain one set of multimodal features corresponding to the detection frame.

16. An electronic device, comprising:
at least one processor; and
a memory in communication connection with the at least one processor; wherein
the memory stores instructions executable by the at least one processor, and the instructions are executed by the at least one processor, so as to enable the at least one processor to perform the method according to claim 6.

17. The electronic device according to claim 16, wherein the output sub-model comprises a decoder and a multilayer perception network, and the inputting the visual encoding feature, the to-be-extracted attribute and the plurality of sets of multimodal features into the output sub-model to obtain the second text information matched with the to-be-extracted attribute and output by the output sub-model comprises:
inputting the visual encoding feature, the to-be-extracted attribute and the plurality of sets of multimodal features into the decoder to obtain a sequence vector output by the decoder;
inputting the sequence vector output by the decoder into the multilayer perception network, to obtain a category to which each piece of first text information output by the multilayer perception network belongs, wherein the category output by the multilayer perception network comprises a right answer and a wrong answer; and
taking the first text information belonging to the right answer as the second text information matched with the to-be-extracted attribute.

18. The electronic device according to claim 17, wherein the decoder comprises a self-attention layer and an encoding-decoding attention layer, and the inputting the visual encoding feature, the to-be-extracted attribute and the plurality of sets of multimodal features into the decoder to obtain the sequence vector output by the decoder comprises:
inputting the to-be-extracted attribute and the plurality of sets of multimodal features into the self-attention layer to obtain a plurality of fusion features, wherein each fusion feature is a feature obtained by fusing one set of multimodal features with the to-be-extracted attribute; and
inputting the plurality of fusion features and the visual encoding feature into the encoding-decoding attention layer to obtain the sequence vector output by the encoding-decoding attention layer.

19. A non-transient computer-readable storage medium storing one or more programs, the one or more programs comprising instructions, which when executed by one or more processors of an electronic device, cause the electronic device to perform the method according to claim 1.

20. A non-transient computer-readable storage medium storing one or more programs, the one or more programs comprising instructions, which when executed by one or more processors of an electronic device, cause the electronic device to perform the method according to claim 6.
